(19) United States
(12) Patent Application Publication
(10) Pub. No.: US 2007/0181743 A1
(43) Pub. Date: Aug. 9, 2007

(54) Method for streamline traced external compression inlet

(75) Inventors: John D. Klinge, Fort Worth, TX (US); Matthew D. Sucher, Benbrook, TX (US); Todd L. Messina, Fort Worth, TX (US)

Correspondence Address: ROBERT A. McLAUCHLAN, P.O. BOX 26780, AUSTIN, TX, 78755, US

(73) Assignee: Lockheed Martin Corporation

(21) Appl. No.: 11/349,656

(22) Filed: Feb. 8, 2006

(51) Int. Cl. B64C 21/10

(52) U.S. Cl. 244/62

(57) ABSTRACT

Embodiments of the present invention provide a Streamline Traced External Compression Inlet (STECI) that represents a new solution to external compression inlet integration issues. STECI utilizes a Computational Fluid Dynamics (CFD) solution produced by a shock-generating shape which is defined by a conceptual design trade study. The shock generating shape may be created by single or multiple surfaces depending on number of upstream oblique shocks required to produce desired flow characteristics at the throat of the inlet. An aperture is then defined according to shaping requirements. This desired aperture is projected onto the forward-most, and aft-most oblique shocks of the flow field. The projected cowl portion of the aperture is then offset downstream from the aft-most oblique shock to allow for air to be “spilled” by the inlet. The resultant shape of the projected/offset cowl and the projected compression surface leading edge is the STECI aperture. Streamline seeds are placed along the STECI aperture and are used to produce streamlines through the CFD solution (which represents a physical flow field). These streamlines provide the basis for the surfaces that make up the portion of the STECI from the leading edge of the bump surface to the inlet throat and the tangencies for surfaces that will exist downstream of the throat. Traditional methods are used to define and loft the subsonic diffuser from the inlet aperture to the engine face.

### TECHNICAL FIELD OF THE INVENTION

The present invention relates generally to engine inlet design, and more particularly, external compression inlet integration within aircraft design.

### BACKGROUND OF THE INVENTION

Low velocity, low pressure, boundary layer air (i.e., low energy air) builds up on the fuselage of a supersonic aircraft in front of the main engine inlets during high speed flight. This low energy air can cause poor engine performance. To address this problem, high-speed aircraft have traditionally employed boundary layer diverter systems to prevent low energy air from entering the air inlet. However, air induction systems often require complex subsystems in order to work properly at high speed. As such, these air inductions systems increase the weight, cost of production, mechanical complexity and cost of maintenance of the aircraft.

Air inlet systems for gas turbine powered supersonic aircraft decelerate the approaching flow to subsonic conditions prior to the engine face. Supersonically, this is accomplished through shock waves or isentropic compression generated externally, internally, or a “mixture” of both. Fixed geometry external compression inlets have typically been used for aircraft designed for short excursions to supersonic conditions, such as the F-16 and F-18, due to the relative simplicity and light weight of these designs. Higher speed capable aircraft, such as the F-15 and F-14, have employed variable geometry external compression inlets to obtain better engine/inlet airflow matching at low speeds and higher performance at supersonic speeds.

High supersonic cruise aircraft typically require maximum efficiency at the cruise point to obtain optimum range and payload. At design point cruise speeds above Mach 2, mixed compression inlet systems become more favorable due to reduced drag relative to an external compression system. Mixed compression inlets have been demonstrated in flight on the A-12/SR-71, D-21, and XB-70. Several other designs have been tested over the past 50 years. All of these mixed compression designs were based on either axisymmetric or two-dimensional compression schemes, in order to minimize shock interactions caused by complex 3D geometry. However, increasing demand for more integrated inlet/airframe concepts has resulted in the need for more exotic inlet aperture shapes.

Another solution provides a “bump” or raised external compression surface to divert low velocity, low energy air away from the aperture of the engine inlet before it can enter. However, such external compression surfaces usually focus solely on boundary layer diversion and not the cowl shape and inner duct walls associated with the cowl in order to create an integrated solution that may address the problems associated with advanced aircraft design.

Further limitations and disadvantages of conventional boundary layer diversion and modeling of and implementing compression surfaces to divert low energy air will become apparent to one of ordinary skill in the art to comparison with the present invention described herein.

### SUMMARY OF THE INVENTION

The present invention provides for the use and design of Streamline Traced External Compression Inlets (STECI) that substantially eliminates or reduces disadvantages and problems associated with previously developed boundary layer diverting systems.

Embodiments of the present invention provide for a STECI and a methodology for designing such an inlet that represents a new solution to external compression inlet integration issues. The STECI concept may be derived using computational fluid dynamics (CFD). This allows an existing external compression, shock generating surface design to be used to obtain a CFD solution with slip wall boundaries at the inlet design point. This existing design serves as the “flow field generator” for the STECI. A high speed cruise inlet is typically designed such that the oblique shock produced by the external compression portion of the inlet lies on or very near the inlet cowl lip at the cruise point, minimizing the amount of air “spilled” by the inlet, but allowing for enough spilled air to maintain inlet airflow stability.

The design of a STECI inlet starts with a CFD solution produced by a shock-generating shape (the flow field generator), which could be as simple as a cone or wedge. The angle of the cone or wedge may be defined by a conceptual design trade study. The flow field generator may also be created by single or multiple complex surfaces. The aperture of the STECI inlet is defined according to shaping requirements. The desired cowl shape is projected onto a surface identical to, but downstream from, the aft-most external oblique shock produced by the flow field generator. The offset between the aft-most shock and the downstream aperture design surface allows for a small amount of air to be “spilled” by the inlet. The segments of the aperture that represent the leading edge of the STECI external compression surface are projected on the forward-most shock surface of the flow field generator. The cowl segments are then connected to the leading edge segments to form a full and continuous aperture. The resultant shape of the projected/offset cowl and the projected bump leading edge is the STECI aperture. Streamline seeds are next placed on the STECI aperture segments and are used to produce streamlines through the flow field generator CFD solution (which represents a physical flow field).

These streamlines provide the basis and tangency-reference for the surfaces that make up the portion of the STECI from the leading edge of the compression surface to the inlet throat. The surface tangencies feed into traditional methods to define and loft the subsonic diffuser from the inlet throat to the engine face.

Streamline tracing the cowl allows for alternate aperture shaping to be employed while producing the desired spillage and minimizing cowl drag, while maintaining the desired internal flow field and inlet performance. Without this technique, 3D shaped external compression inlets would require more extensive testing and design iterations to predict and optimize their performance. The techniques provided by embodiments of the present invention allow for the design of edge aligned, swept aperture shapes without incurring the aerodynamic penalties typically encountered with such designs.

By producing the design from the desired solution, the performance can easily be predicted using simple 1-D methods. The STECI has been computationally proven through CFD to produce uniform flow at the throat with low lip-loss and intended spillage characteristics.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 depicts an embodiment of an external compression surface and associated inlet which may be produced in accordance with an embodiment to the present invention;

FIG. 2 illustrates boundary layer diversion associated with embodiments of the present invention;

FIG. 3A provides a bi-cone geometry that may be used to establish the compression surface and cowl opening geometry in accordance with an embodiment to the present invention;

FIG. 3B illustrates two oblique shocks generated by the geometry depicted in FIG. 3A;

FIG. 4 depicts the addition of a surface identical to the aft-most oblique shock, located slightly downstream with an embodiment of the present invention;

FIG. 5 depicts a projection of cowl segments and leading edge compression surface segments onto a surface identical to, and downstream from, the aft-most oblique shock and also onto the forward-most oblique shock in accordance with embodiments of the present invention;

FIG. 6 depicts how seed points based on the projection of cowl segments and leading edge compression surface segments surfaces downstream from the aft-most oblique shock and the forward-most oblique shock may be used to generate streamlines in accordance with embodiments of the present invention;

FIG. 7 depicts a mesh of the compression surface and cowl surface based on the streamlines generated with reference to FIG. 6;

FIG. 8 depicts the compression surface and cal inlet defined by the mesh of FIG. 8;

FIG. 9 depicts the integrated streamlined traced external compression inlet resulting from the processes associated with FIGS. 3A through 8;

FIG. 10 provides a logic flow diagram describing one method of generating a streamlined traced external compression inlet in accordance with one or more embodiments in the present invention; and

FIG. 11 provides a logic flow diagram in accordance with another embodiment of the present invention operable to determine external compression surfaces associated with a ducted inlet.

### DETAILED DESCRIPTION OF THE INVENTION

Preferred embodiments of the present invention are illustrated in the FIGs., like numerals being used to refer to like and corresponding parts of the various drawings.

Historic external compression air induction systems for gas turbine powered supersonic aircraft do not meet the current needs for inlet/airframe integration. These needs are driven by factors such as tailored aperture shapes, drag minimization, and propulsion performance. Embodiments of the present invention provide a method to create a Streamline Traced External Compression Inlet (STECI) that substantially addresses Inlet/Airframe integration issues. This method results in fewer design iterations than traditional historic external compression inlets.

Historical supersonic external compression inlets are based on simple 2D ramp or Axisymmetric configurations, or have been designed using Caret shaping or Diverterless Supersonic Inlet methodologies. None of these historical configurations or methods incorporates the cowl shape and inner duct walls associated with the cowl into a streamlined traced inlet solution. As a result, extra design iterations were needed to address lip loss, 3D effects, spillage, and other undesirable performance traits that became apparent once Computational Fluid Dynamics (CFD) and/or wind tunnel tests were used to quantify performance.

Embodiments of the present invention provide for the design and implementation of exotic engine inlets which may be used in high performance vehicles such as tactical aircraft. These exotic aperture shapes can be obtained by tracing particle streamlines from existing CFD (Computational Fluid Dynamics) solutions. The STECI is a 3D external compression inlet design concept derived from CFD by streamline tracing the supersonic section from a shock-generating geometry or “flow field generator”.

The STECI includes an external inlet compression surface combined with a cowl aperture shape. This inlet eliminates the need for traditional boundary layer diverters, overboard bypass systems, and boundary layer bleed systems which have been used in conventional air induction systems. Thus, the STECI may reduce vehicle (aircraft) weight, cost and complexity. These features are eliminated because of the compression surface and cowl work synergistically to provide boundary layer diversion capability.

The compression surface is designed to produce a suitable inlet-compatible flow field. The span wise static pressure of the surface can begin to divert boundary layer air outward. The pressure differential between the inlet and the area surrounding the inlet further diverts the boundary layer air outboard. The compression surface serves to reduce the Mach number just upstream of the terminal shock, thus reducing the tendency for shock-induced flow separation. The cowl is positioned to minimize the intake of low energy air and maximize the intake of free stream air within the inlet.

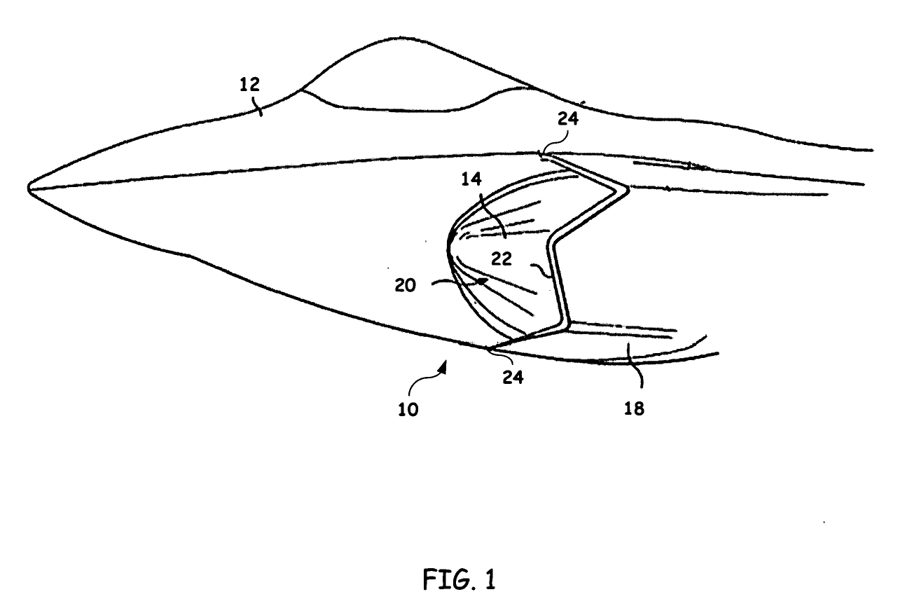

FIG. 1 is an illustration of a side mounted compression inlet 10 mounted to the body of a vehicle such as aircraft 12. Inlet 10 includes a raised compression surface 14 and a cowl 18 formed outwardly from the fuselage of aircraft 12. Compression surface 14 begins to rise outwardly from the body of the aircraft prior to opening 20. Low energy air will contact compression surface 14 prior to arriving at the opening (inlet) 20. The shape of the compression surface 14, opening 20 and the ducted surfaces contained within cowl 18 may be varied based upon a design methodology which will be discussed in further detail. Opening 20 ideally receives free stream air flow while lower energy boundary air flow is rejected by inlet 10. This rejection is based on the shape and position of opening 20 and compression surface 14. The leading edge or lip 22 of opening 20 extends from a closure point 24 where the duct joins the fuselage of aircraft 12.

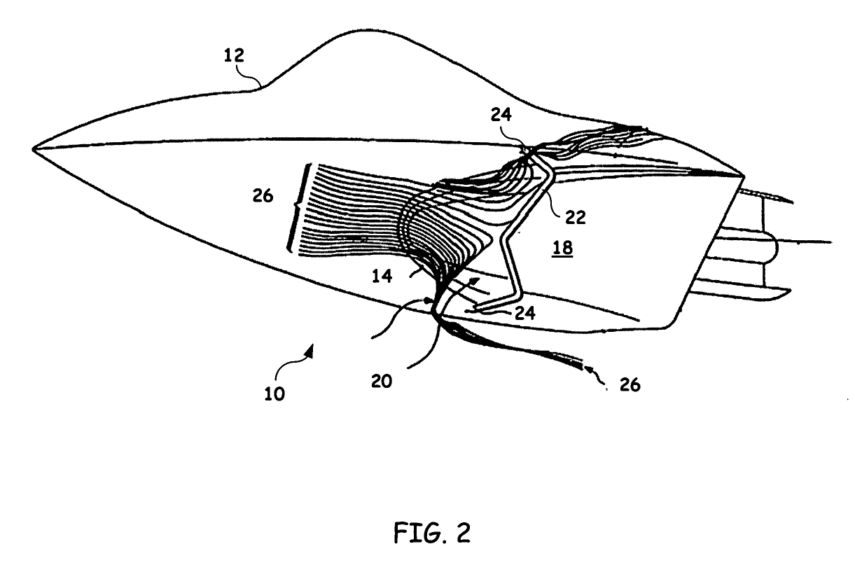

Compression surface 14 and cowl 18 work together to divert substantially all of the low energy air from inlet 10. As low energy, boundary layer air flows towards inlet 10, the low energy air remains approximately near the vehicle surface. As shown in FIG. 2, prior to reaching inlet opening 20 low energy air 26 contacts the compression surface 14. This surface alters the path of the low energy air away from opening 20. The shape of opening 20 within cowl 18 may establish a pressure differential so that the pressure near opening 20 and inside inlet 10 is higher than the pressure outside of inlet 10. The shape of the cowl creates a significantly lower pressure at closure points 24. Thus, once boundary layer air begins moving outward, due to compression surface 14, low energy air 26 moves to lower pressure regions near the closure points and outside the inlet rather than the higher pressure regions near opening 20 of inlet 10.

FIG. 2 provides streamlines obtained from a computational fluid dynamic (CFD) simulation that models this inlet's flow characteristics. This simulation illustrates a pressure field around inlet 10 where the air flows in and around the inlet. As indicated previously the interior of inlet 10 and region near opening 20 are higher pressure regions relative to the exterior of cowl 18. Lines 26 represent the paths of boundary layer or low energy air travel. As previously described, compression surface 14 and cowl 18 work together to divert low energy air from being ingested within the inlet.

Previous techniques of developing and defining compression surfaces have often relied on expensive wind tunnel tests of actual models of proposed compression surfaces and cowl configurations on an aircraft. To properly model the actual performance of this geometry the overall aircraft design needs to be taken into account as well. Most design process focus on the inlet design but not the overall integrated design of the inlet within a given vehicle. The present invention provides a methodology for determining the compression surface and cowl geometry integrated within a vehicle that eliminates much of the modeling associated with prior solutions.

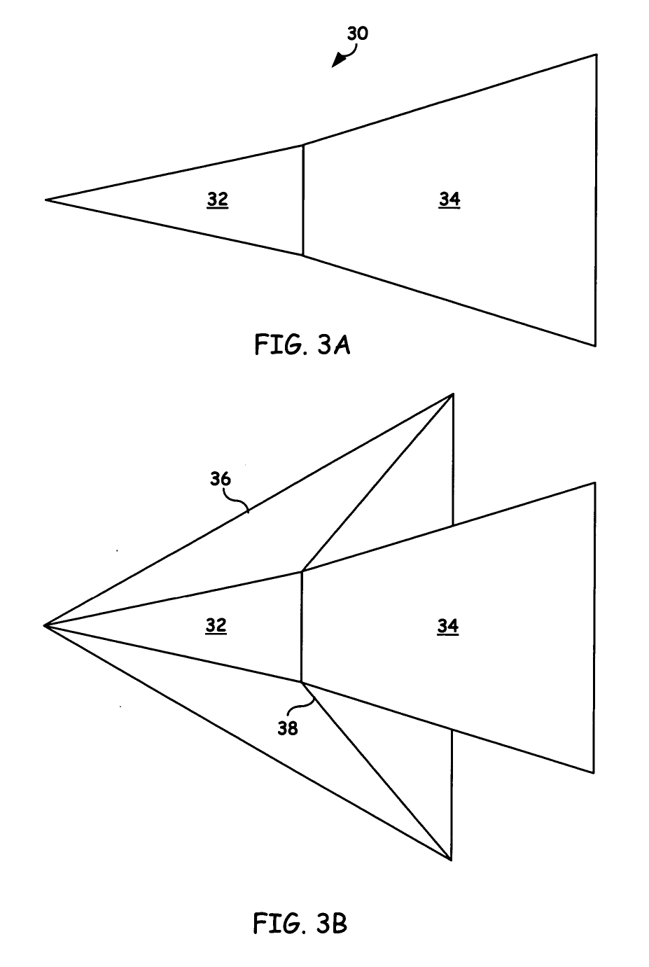

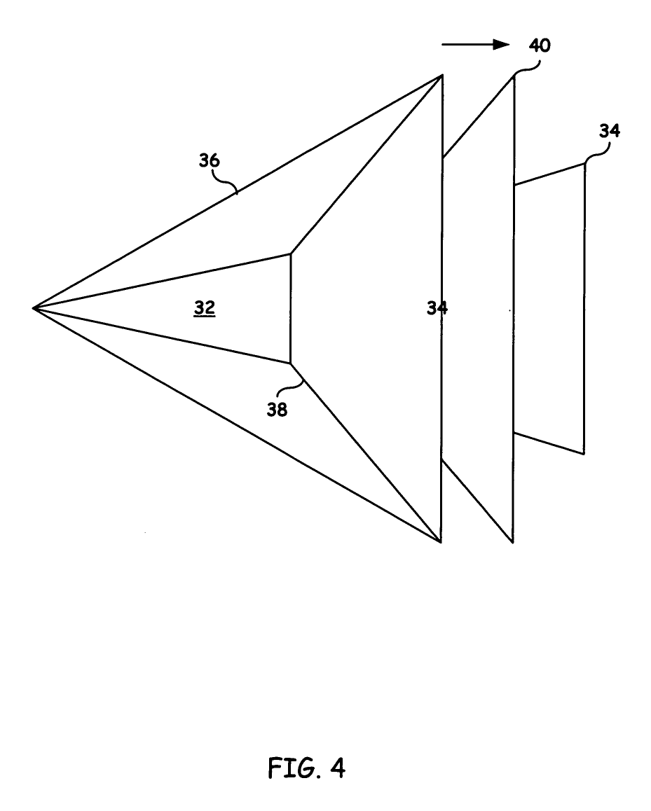

FIGS. 3A and 3B provide an example of how a bi-cone flow field generator may be used to establish the compression surface and cowl opening geometry. This external compression surface 30 is defined by two conical surfaces 32 and 34 wherein the angles of the cone associated with these conical surfaces differ. This compression surface 30 may be defined by a one dimensional (1-D) trade study to meet compression requirements. However it should be noted that the present invention is not constrained to conical or symmetrical compression surfaces, asymmetrical or non-conical surfaces may be used as may be required when examining the integrated effect of surfaces. In FIG. 3B, a flow field generator (i.e., computational fluid dynamics (CFD) analysis tool) is used to produce oblique shocks 36 and 38 as defined by the (1-D) trade study. This shock system can then be modeled within a computer-aided design (CAD) system. The rearmost shock or second shock 38 may be duplicated and positioned aft, as shown in FIG. 4, for the purpose of providing a surface on which to draw a cowl geometry, and for the purpose of introducing a small amount of spillage. Spillage may increase the stability margin of the inlet to be associated with the compression surface.

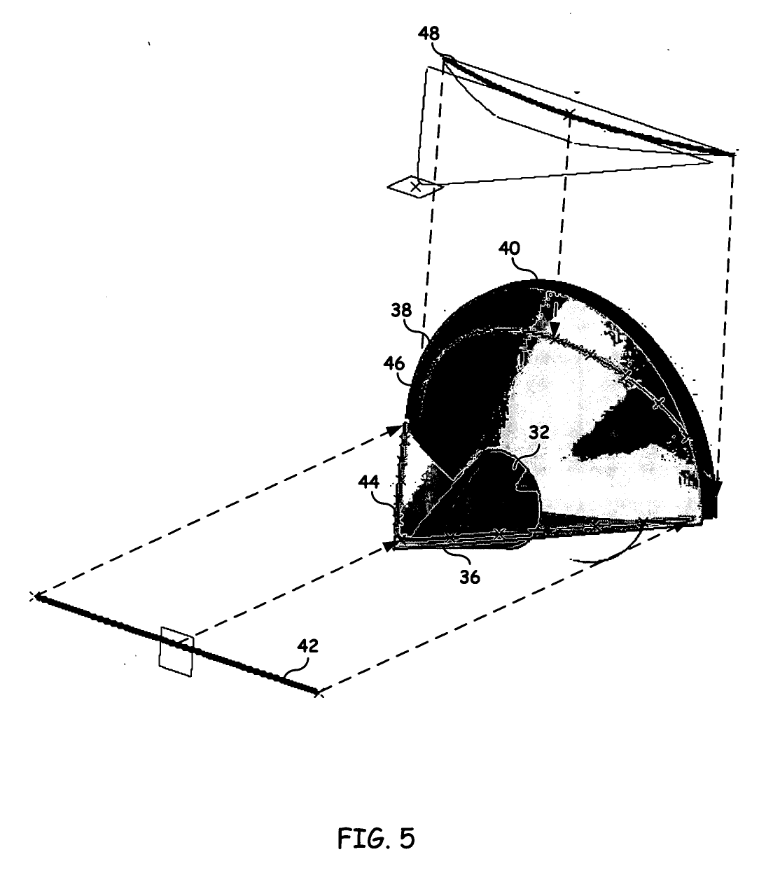

In FIG. 5, a straight line 42, which may be curved or made up of several segments, may be projected horizontally onto the first shock 36 in order to form the leading edge 44 of the external compression surface 14. Boundary 46 of the desired cowl shape of the inlet may be determined by projecting a cowl shape 48 to the surface that was made identical to rearmost shock 40, and translated aft to form the cowl leading edge. Although the surface that was made identical to the rearmost shock as shown in FIG. 4 is translated aft to induce additional stability for the inlet this is not necessarily required.

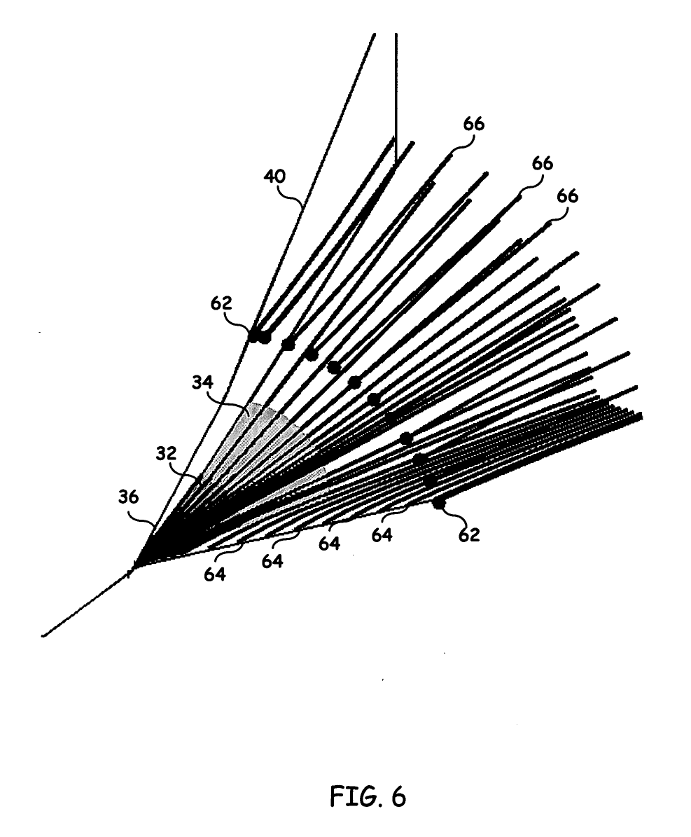

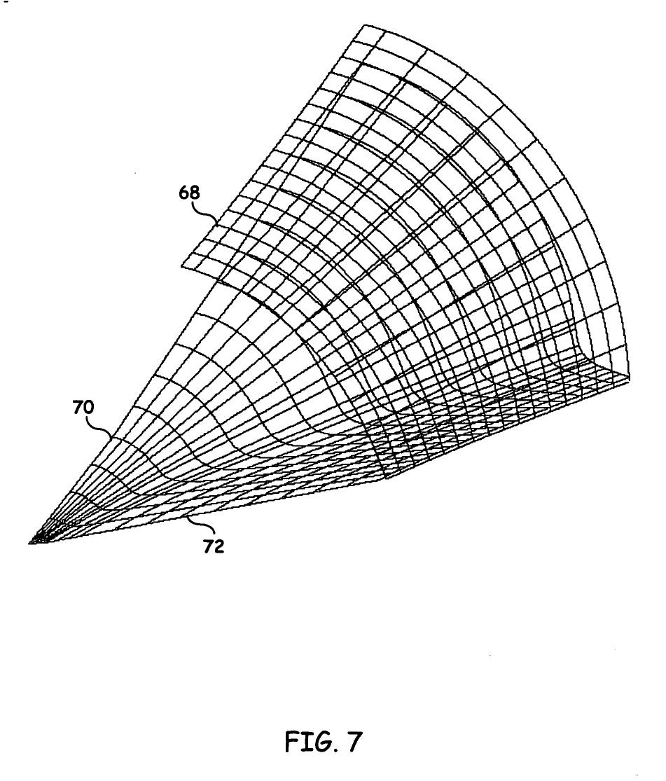

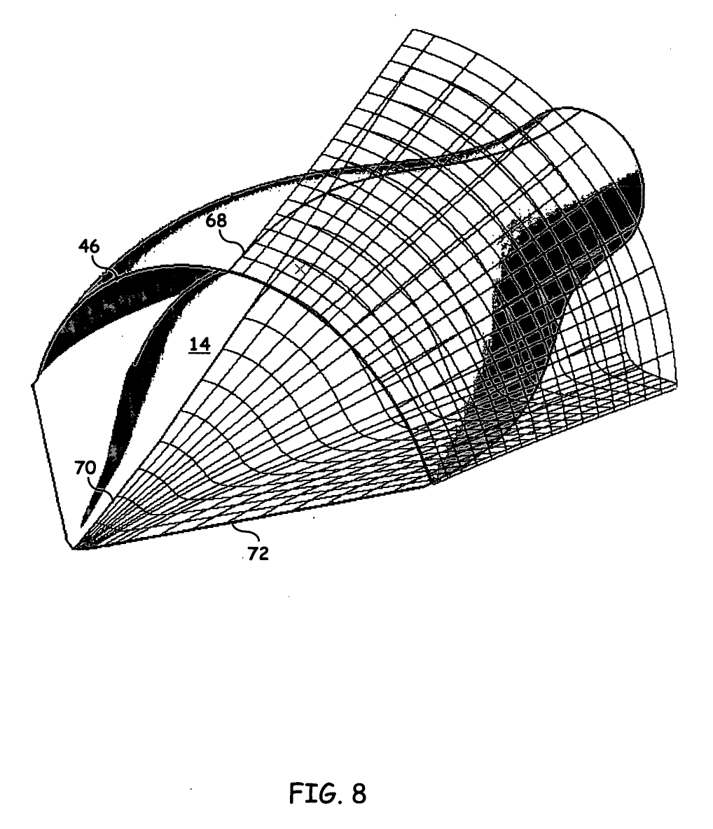

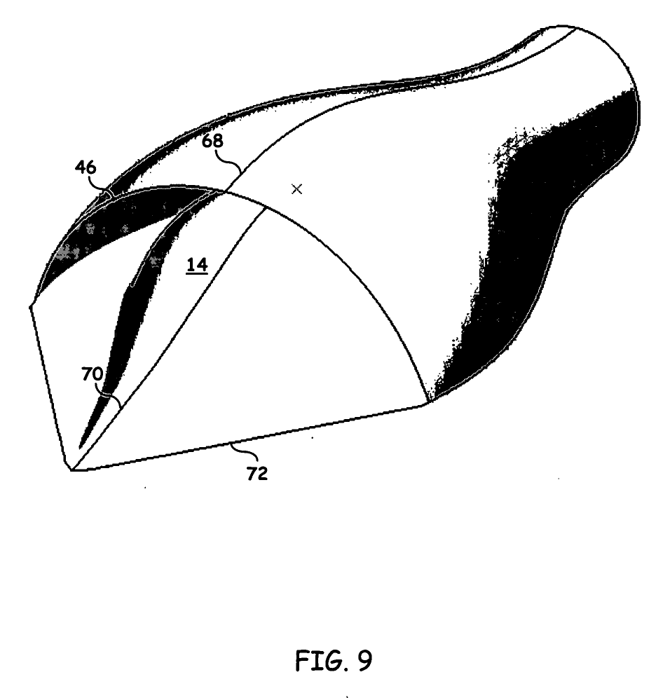

In FIG. 6, cowl seed points 62 and compression surface seed points 64 may be imported into the flow field generator CFD solution to propagate streamlines 66 downstream from each seed point location. Streamlines 66 may be meshed in a CAD environment as shown in FIG. 7. The cowl mesh 68 is used to establish flow tangency at the cowl lip or the cowl surfaces while the bump mesh 70 is surfaced directly from the leading edge 72 of the bump to the throat. Downstream surfaces from the cowl plane or throat may be lofted as shown in FIG. 8 in order to transition from the inlet to the circular engine face. These surfaces are then modified to improve surface continuity and smoothness while eliminating or reducing the opportunity for low energy air to negatively impact inlet performance. The result is the integrated compression surface and cowl geometry depicted in FIG. 9.

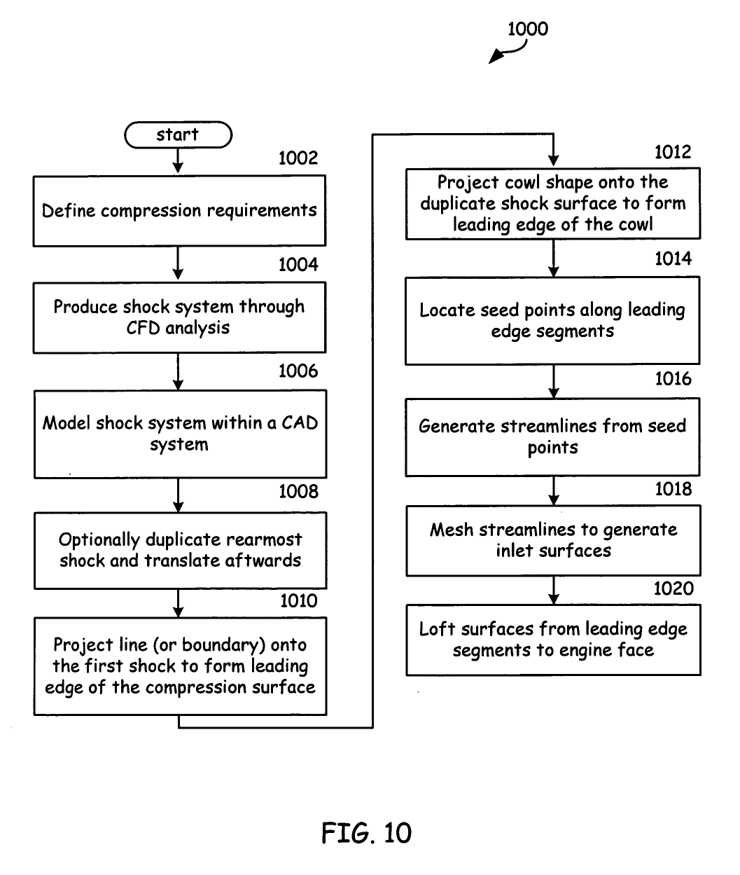

FIG. 10 provides a logical diagram that describes a methodology of determining the geometry of a streamline traced external compression inlet in accordance with embodiments of the present invention. Operations 1000 begin by defining compression requirements. This may be accomplished using a trade study or other like mechanism. This may utilize a conical shape to define the compression requirements. However, embodiments of the present invention need not be limited to such shapes. Rather any desired compression shape or multi-segmented shape may be used. The shapes chosen may be determined by other factors. In step 1004, flow field generators are used to produce shock systems which consist of one or more oblique shocks, such as those defined by the 1-D trade study as illustrated in FIG. 3B. In step 1006, these shocks are modeled within a CAD system. The rearmost shock may optionally be duplicated. The duplicated shock surface may be translated downstream. This translation allows some spillage which may improve stability of the engine inlet. A line, curve, or multiple segments, may be projected onto the forward-most shock to define the leading edge of the external compression surface in step 1010. Then, a cowl shape may be projected onto the duplicated/translated shock surface in step 1012. This intersection defines the cowl leading edge. In step 1014, seed points within the compression surface leading edge and the cowl leading edge are identified. In step 1014, the seed points are imported into the flow field generator CFD solution and allowed to propagate. In step 1016, streamlines downstream of each seed point are generated within the flow field generator CFD solution. In step 1018, these streamlines may be meshed in a CAD environment in order to create a cowl mesh and compression surface mesh. The cowl mesh surface and compression mesh surface may be lofted to the ducting coupling to the engine face. Further processing may be performed in order to eliminate other discontinuities and improve performance of the surface.

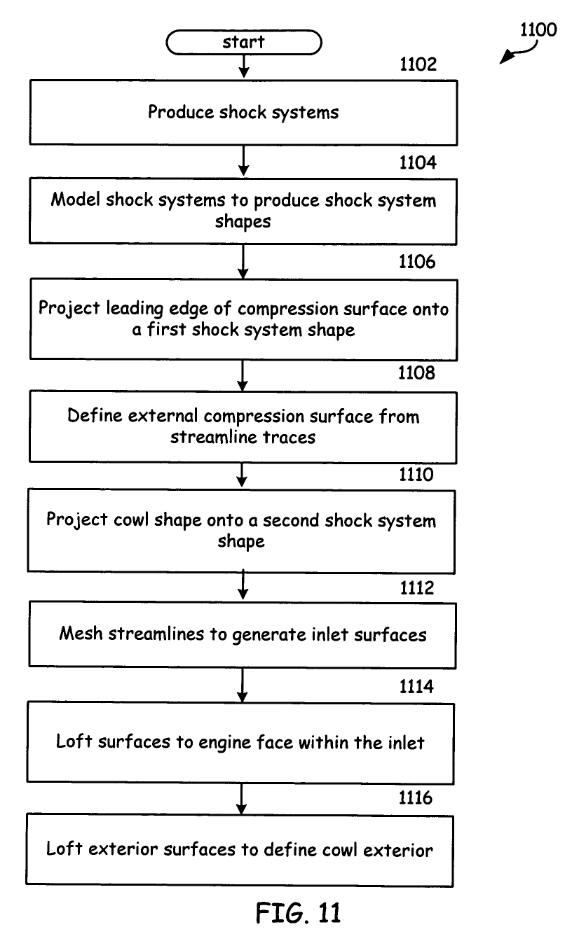

FIG. 11 provides a logic flow diagram in accordance with another embodiment of the present invention operable to determine external compression surfaces associated with a ducted inlet. Operations 1100 begin in step 1102 with the production of a forward-most shock and aft-most shock (which may be the same oblique shock or two separate oblique shocks) based on the compression requirements associated with a ducted inlet. In step 1104 the shock system is modeled to produce the shapes of one or more shocks. This may be done with a computer-aided design system or other traditional means known to those having skill in the art. In step 1106 a segment representing the leading edge of the compression surface is projected onto the forward-most modeled shock shape. The external compression surface itself may be defined in step 1108 by producing streamline traces from the leading edge of the external compression surface using seed points located at the leading edge wherein virtual particles are allowed to trace the flow field from the leading edge. A cowl shape is projected in step 1110 onto the surface duplicated from the aft-most oblique shock wherein an intersection of the duplicated shock surface and the cowl shape define a leading edge of the cowl. To better define the external compression inlet, the streamline traces may be meshed within a CAD program in step 1112 in order to generate a three-dimensional (3-D) surface. The 3-D surface may then be lofted to the interior surface of the ducted inlet in step 1114. Step 1116 additionally lofts streamline traces from the exterior of the leading edge of the cowl to define the exterior of the cowl.

Embodiments of the present invention provide an advanced inlet concept that represents a new solution to external compression inlet integration issues. The STECI starts with a CFD solution produced by a shock-generating shape which may be defined by a conceptual design trade study. The shock generating shape may be created using single or multiple surfaces depending on the number of upstream oblique shocks required to optimize the flow field at the throat of the inlet. An aperture is then defined according to shaping requirements. This desired aperture is projected onto surfaces identical to or similar to the external shock system produced by the shock generating shape. The projected cowl portion of the aperture is drawn on a surface duplicated from the aft-most oblique shock, and offset downstream from the shock to allow for air to be “spilled” by the inlet. The resultant shape of the projected/offset cowl and the projected bump leading edge is the STECI aperture. Streamline seeds are next placed along the STECI aperture and are used to produce streamlines through the CFD solution (which represents a physical flow field). These streamlines provide the basis for the surfaces that make up the portion of the STECI from the leading edge of the bump surface to the inlet throat and the tangencies for surfaces that will exist downstream of the throat. Traditional methods are used to define and loft the subsonic diffuser from the inlet aperture to the engine face. The STECI method can be used with more complex shock generating shapes with multiple sections in developing integrated geometry operable to supersonic cruise Mach numbers.

Embodiments of the present invention overcome problems associated with traditional supersonic external compression inlets driven by propulsion performance that did not address airframe/inlet integration issues. The geometries provided by the present invention support integration driven by total system performance, including the need for more exotic inlet aperture shapes and boundary layer management methods. STECI integration concerns during the initial design cycle instead of an afterthought. This allows for rapid development of highly integrated external compression inlets which provide excellent propulsion performance without compromising airframe/inlet integration.

As one of average skill in the art will appreciate, the term “communicatively coupled”, as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. An external compression inlet operable to divert boundary layer air from a ducted inlet, comprising:
a compression surface having a surface raised outwardly from a body to which the ducted inlet is coupled, wherein the compression surface is operable to divert the boundary layer air prior to the boundary layer air entering the inlet, the compression surface positioned prior to an opening of the ducted inlet and extending toward the ducted inlet; and
a cowl coupled to the compression surface, wherein the cowl defines the opening of the ducted inlet;
the cowl working in conjunction with the compression surface to further divert the boundary layer air and substantially reduce ingestion of the boundary layer air within the ducted inlet;
wherein:
the compression surface is defined by streamline traces of free stream air from seed points; and
the opening of the ducted inlet is defined by streamline traces of free stream air from seed points;
an upstream-most shock comprises a shock generated from the leading edge of a compression surface within a supersonic flow field; and
a downstream-most shock comprises a shock generated from a downstream section of a compression surface within the supersonic flow field, wherein the downstream-most shock is duplicated in size and shape, and the duplicate surface, representing the intended cowl plane, is translated downstream to allow spillage of air from the ducted inlet.

2. The external compression inlet of claim 1, wherein the streamline traces of free stream air are computed through use of computational fluid dynamics (CFD).

3. (canceled)

4. (canceled)

5. The external compression inlet of claim 1, wherein a computational fluid dynamics (CFD) solution based on said at least one compression surface is used to derive streamline traces.

6. The external compression inlet of claim 5, wherein the body comprises a flow field generator.

7. A method for diverting boundary layer air from a ducted inlet comprising:
altering the path of the boundary layer air flowing toward the ducted inlet by placing a compression surface on a body to which the ducted inlet is coupled in the path of the boundary layer air; and
creating a pressure differential in the interior of the ducted inlet by coupling a cowl to the body, wherein the cowl is operable to substantially prevent the boundary layer air from entering the ducted inlet;
wherein:
the compression surface is defined by streamline traces of free stream air from seed points;
the opening of the ducted inlet is defined by streamline traces of free stream air from seed points;
an upstream-most shock comprises an oblique shock derived from the forward-most section of a flow field generator within a supersonic flow field; and
a downstream-most shock comprises a oblique shock derived from the aft-most section of a flow field generator within the supersonic flow field, wherein a surface duplicated from the downstream-most shock system is translated downstream to allow spillage of air from the ducted inlet.

8. The method of claim 7, wherein the streamline traces of free stream air are computed through use of computational fluid dynamics (CFD).

9. (canceled)

10. (canceled)

11. The method of claim 7, wherein a computational fluid dynamics (CFD) solution based on said at least one body surface is used to derive streamline traces.

12. The method of claim 11, wherein the body comprises a flow field generator.

13. A method operable to determine external compression surfaces associated with a ducted inlet comprising:
producing one or more oblique shocks based on compression requirements associated with the ducted inlet;
modeling oblique shock shapes associated with the produced shock system;
projecting an aperture segment corresponding to a leading edge of the inlet compression surface onto a modeled forward-most oblique shock, wherein an intersection of a first shock and aperture segment define a leading edge of the external compression surface;
producing streamline traces from the leading edge of the external compression surface, wherein the streamline traces define the external compression surface; and
projecting a cowl shape onto a duplicated aft-most oblique shock, wherein an intersection of the duplicated aft-most shock and the cowl shape define a leading edge of the cowl.

14. The method of claim 13, wherein the streamlines originate from seed points within the leading edge of the external compression surface.

15. The method of claim 13, further comprising producing streamline traces from the leading edge of the cowl, wherein the streamline traces define an external surface of the cowl.

16. The method of claim 15, wherein the streamlines originate from seed points placed on the leading edge of the cowl.

17. The method of claim 13, wherein the surface duplicated from the aft-most oblique shock is translated downstream to induce spillage of airflow over the ducted inlet.

18. The method of claim 13, further comprising defining the compression requirements through a trade study.

19. The method of claim 13, wherein the shock system is modeled within a computer system.

20. The method of claim 13, wherein the streamlines are propagated from seed points using a flow field generator CFD solution.

21. The method of claim 13, wherein the aperture segment is comprised of one or more simple or complex lines or curves, projected from any angle.

22. The method of claim 13, wherein the compression surface is lofted to an internal surface of the ducted inlet, and wherein the ducted inlet couples to an engine face.

23. A method operable to determine external compression surfaces associated with a ducted inlet coupled to an engine face, the method comprising:
defining the compression requirements for the ducted inlet;
producing one or more oblique shocks based on the compression requirements;
modeling oblique shock shapes associated with one or more oblique shocks;
translating a surface duplicated from a aft-most oblique shock downstream to induce spillage of airflow over the ducted inlet;
projecting an aperture segment onto a forward-most oblique shock, wherein an intersection of a upstream oblique shock and the aperture segment define a leading edge of the external compression surface, and wherein the streamlines originate from seed points within the leading edge of the external compression surface;
producing streamline traces from the leading edge of the external compression surface, wherein the streamline traces define the external compression surface;
projecting a cowl shape onto a surface duplicated from the aft-most oblique shock, wherein an intersection of the surface and the cowl shape define a leading edge of the cowl.
producing streamline traces from the leading edge of the cowl, wherein the streamline traces define an external surface of the cowl, and wherein the streamlines originate from seed points within the leading edge of the cowl; and
lofting the compression surface to an internal surface of the ducted inlet.

24. The method of claim 23, wherein the oblique shocks are modeled within a computer system.

25. The method of claim 23, wherein the streamlines are from seed points using a flow field generator CFD solution.

26. The method of claim 23, wherein the aperture segment is comprised of one or more simple or complex lines or curves, projected from any angle.
